(19) United States
(12) Patent Application Publication
(10) Pub. No.: US 2026/0196846 A1
(43) Pub. Date: Jul. 9, 2026

(54) METHOD FOR OPERATING A CHARGING DEVICE FOR A VEHICLE AND CONTROL UNIT FOR A CHARGING DEVICE

(71) Applicant: Robert Bosch GmbH, Stuttgart (DE)

(72) Inventors: Christoph Van Booven, Bietigheim-Bissingen (DE); Thomas Kopp, Ostfildern (DE)

(21) Appl. No.: 19/133,347

(22) PCT Filed: Oct. 5, 2023
(86) PCT No.: PCT/EP2023/077538

§ 371 Date: May 28, 2025

(30) Foreign Application Priority Data
Nov. 28, 2022 (DE) 10 2022 212 669.6

(51) Int. Cl. H02J 7/02; B60L 50/60; B60L 53/22; B60L 53/60; H02J 7/34

(52) U.S. Cl. CPC H02J 7/02; B60L 53/22; B60L 53/60; H02J 7/345; B60L 50/60; B60L 2210/10; H02J 2207/20

(57) ABSTRACT

Method (800) for operating a charging device for a vehicle, wherein the charging device (500) comprises an input circuit, an intermediate capacitor (CZ) and a bi-directional DC-DC converter, wherein the method (800) is configured to at least partially reduce or discharge an electrical charge applied to the output side of the DC-DC converter (450), comprising the steps of: receiving (810) a signal for discharging the electrical charge applied to the output side of the DC voltage converter (450), determining (820) a measured value which characterizes a voltage applied to the output side of the DC-DC converter (450), operating (830) the DC-DC converter (450) in a discharge mode such that the charge applied to the output side is transported in the direction of the intermediate capacitor (CZ), until the determined measured value corresponds to a predeterminable threshold value which characterizes a falling below of a predeterminable voltage value applied to the DC-DC converter (450) on the output side

### BACKGROUND

The invention relates to a method for operating a charging device for a vehicle and a control unit for a charging device. The invention also relates to a charging device with a control unit, a drive train with a control unit or a charging device, a vehicle with a drive train, and a computer program and a computer-readable storage medium.

Method for operating a charging device, for example in vehicles with an electric drive in an electric drive in an electric vehicle or a hybrid vehicle, are used to recharge batteries, preferably accumulators or traction batteries, from an electrical energy source, preferably an external alternating voltage source or the public alternating voltage power supply. The charging device converts sinusoidal alternating current from the external power source into direct current.

Preferably, charging devices have two-stage power electronics. A first stage, the so-called power-factor-correction stage, the PFC stage, converts the sinusoidal input voltage from the alternating voltage power grid into a direct voltage. A second stage consists of a direct voltage converter or DC/DC converter that ensures galvanic isolation via a transformer and adjusts the voltage levels. Preferably, the output voltage and/or the output current for charging the battery is adjusted by means of an electric circuit and a controller. An intermediate capacitor is arranged between the two stages, which buffers the power pulsation in the double frequency of the alternating voltage current of the power source. These topologies allow for the maintenance of a near sinusoidal input current on the power grid side to meet power grid-side standards, a galvanic isolation between the power grid and vehicle to meet safety requirements, and a constant direct voltage output current on the side of the battery to minimize the load on the battery during charging.

In an electric drive vehicle, the battery is further connected to an inverter to supply energy to the electric drive machine. A DC-DC converter is connected in parallel to the inverter to supply a low-voltage network, or an on-board power supply, of the vehicle to supply the control devices with energy. Not least to prevent electromagnetic interference, a consumer in a high-voltage network, such as an inverter, a DC-DC converter, comprises capacitors between the high-voltage connections that filter out rapid changes in the high-voltage voltage that occur during operation.

In the event of an accident or before carrying out repairs on the vehicle, the electrical charge in the capacitors of the vehicle's high-voltage or high-voltage electrical system must be reliably discharged so that there is no risk of injury to persons if they touch or come into contact with cables or components of the high-voltage electrical system. As is disclosed in publication EP 2 516 197 B1, corresponding discharge circuits are usually provided in a decentralized manner in individual components of the high-voltage network, e.g., in inverters. The discharge circuits comprise additional components for this purpose, which increase the required installation space and weight. There is therefore a need for methods that at least partially centralize such discharge circuits, replace them in part or in full, or accelerate the discharge of the high-voltage network.

### SUMMARY

The present invention provides a method for operating a charging device for a vehicle. The charging device comprises, on the input side, an input connection unit for connecting a single-phase or multiphase alternating voltage with n phases, wherein n is greater than or equal to 1, and an input circuit connected thereto for supplying a direct voltage to at least a two-pole intermediate connection. Such an input circuit comprises a rectifier circuit for converting the input-side alternating voltage into an output-side direct voltage. Preferably, the input circuit also comprises a PFC stage. A preferred topology for such an input circuit is a 3L TNPC, a Vienna rectifier or a (totem pole) PFC circuit. At least one intermediate capacitor is connected between the positive intermediate connection and the negative intermediate connection. A bi-directional DC-DC converter is connected to the intermediate connection on the input side. The bi-directional DC-DC converter is configured to convert the DC voltage applied to the intermediate connection into a charging voltage during charging mode and to supply it to a high-voltage network connectable to the output side of the DC-DC converter, preferably to a connectable battery. The method is configured to at least partially reduce an electrical charge applied to the DC-DC converter on the output side or, preferably, to discharge capacitances present in the connectable high-voltage network. Preferably, the applied electrical charge is stored in at least one capacitance of the connectable high-voltage network or in at least one capacitance of a component of the high-voltage network. The method comprises the steps of: receiving a signal for discharging the electrical charge applied to the output side of the DC-DC converter. This signal is preferably determined within the charging device or by an external control device of the vehicle and received by the charging device, preferably the control unit. Preferably, this signal is determined, generated, and sent depending on a malfunction, a short circuit, an insulation fault, a diagnosis, the performance of a repair, the vehicle being turned off or parked, or the detection that a plug, preferably a signal plug, is not connected to the charging device. Further steps are: determining a measured value that characterizes a voltage applied to the output side of the DC-DC converter. operating the DC-DC converter in a discharge mode such that the charge applied to the output is transported in the direction of the intermediate connection and the intermediate capacitor is charged until the measured value corresponds to a predetermined threshold value which characterizes a voltage value applied to the DC-DC converter on the output side which is below a predetermined value.

An advantageous method is provided which enables the capacitance or capacitors of a high-voltage network connected to the charging device to be discharged centrally. For this purpose, the charge applied to the output side is transferred to the input side by reversing the bi-directional DC-DC converter of the charging device, thereby charging the intermediate capacitor.

An external energy source is preferably a single-phase or multiphase, preferably three-phase, alternating voltage network, preferably the public low-voltage network, preferably for supplying households, industry, and/or infrastructure. Preferably, in a North American region or Japanese region, this is a 120 or 240 volt single-phase alternating voltage network. Preferably, in a Chinese or European region, this is a three phase alternating voltage power system of about 230 Volts. For charging mode of the charging device, the charging device is preferably connected to a corresponding alternating voltage power supply via the n-phase input connection unit or connected to the corresponding alternating voltage. Preferably, the n-phase input connection unit comprises a neutral terminal for connecting a neutral conductor of the alternating voltage power system to be connected. Preferably, a battery to be charged is an accumulator or a traction battery by means of which energy is supplied to an electric drive train of a vehicle. A rectification circuit is preferably a rectifier for converting the alternating voltage current into a direct voltage current. A high side switch or a low side switch of a semiconductor bridge is preferably a power semiconductor switch comprising an intrinsic diode, preferably an IGBT or MOSFET, preferably based on Si, SiC or GaN technology. Preferably, the expression connecting, for example, a center pickup to a connecting line, means contacting or connecting the components by means of an electrically conductive line or a galvanic connection. The expression blocking, preventing, decoupling or preventing a current flow means disconnecting an electrically conductive line or connection. Preferably, the expression “switched” is used synonymously with “electrically connected,” wherein “switchably connected” means that an electrical connection can be established or disconnected, preferably by means of a switch or switching element. Preferably, the expression arranged is used to define the position of an electrical component, preferably a switch or switching element, within the circuit topology, comprising an electrical connection to the adjacent electrical components.

In one embodiment, the method comprises the further step of discharging the intermediate capacitor by means of a discharge circuit. Preferably, the intermediate capacitor is discharged by connecting parasitic resistors or a discharge resistor to it.

An advantage is provided by a method that enables the capacitance or capacitors of a high-voltage network connected to the charging device to be discharged centrally. To this end, the charge is first transferred from the high-voltage network to the intermediate capacitor, which is discharged by means of a discharge circuit.

The invention also relates to a control unit for a charging device which is configured to carry out the method described. Preferably, the control device is a charging control unit.

Advantageously, a control unit is provided which carries out the described method. For this purpose, the DC-DC converter is controlled such that the capacitances or capacitors of the high-voltage network connected to the charging device are discharged and the charge is transferred to the intermediate capacitor.

The invention also relates to a charging device with a control unit as described. The charging device comprises, on the input side, an input connection unit for connecting a single-phase or multiphase AC voltage with n phases, wherein n is greater than or equal to 1, and an input circuit for supplying a DC voltage to a two-pole intermediate connection. An intermediate capacitor is connected between the positive intermediate connection and the negative intermediate connection. A bi-directional DC-DC converter is connected to the intermediate connection on the input side and is configured to convert the DC voltage applied to the intermediate connection into a charging voltage during charging mode and to supply it to a high-voltage network that can be connected to the output side of the DC-DC converter. Preferably, the DC-DC converter is configured to transport the charge applied to the output side in the direction of the intermediate connection during discharge mode and to charge the connected intermediate capacitor.

Advantageously, a charging device is provided which is configured by means of the control unit to discharge the capacitances or capacitors of the high-voltage network connected to the charging device during a discharge mode.

In one embodiment, the intermediate capacitor of the charging device comprises at least one electrolytic capacitor. Electrolytic capacitors are particularly suitable for this application because they are high-voltage and cycle-resistant.

A capacitor type that is particularly preferred for this application is provided.

In one embodiment, the bi-directional DC-DC converter comprises at least one LLC, CLLC, or dual active bridge circuit. A circuit topology of the bi-directional DC-DC converter with or without galvanic isolation can also be used depending on the boundary conditions of the application.

Suitable circuit types for use in a bi-directional DC-DC converter are advantageously provided.

Furthermore, the invention relates to a drive train of a vehicle with a control unit or a charging device as described above, wherein the drive train comprises in particular a traction battery, an inverter and/or an electric machine.

Advantageously, a drive train of an electric vehicle is provided with a control unit or a charging device which is configured to discharge the capacitances or capacitors of the high-voltage network connected to the charging device during a discharge mode by means of the charging device.

The invention further relates to a vehicle having a drive train, as described above.

Advantageously, a vehicle with an electrified drive train with a simplified discharge process is provided.

The invention further relates to a computer program comprising commands which, when the program is executed by a control unit, cause it to carry out the method described.

The invention also relates to a computer-readable storage medium comprising commands which, when executed by a control unit, cause it to carry out the method described.

It is understood that the features, characteristics, and advantages of the method apply accordingly to the control unit, the charging device or the drive train and the vehicle, and vice versa.

### BRIEF DESCRIPTION OF THE DRAWINGS

Further features and advantages of embodiments of the invention are apparent from the following description with reference to the accompanying drawings.

The invention will be explained in further detail hereinafter with reference to the drawings:

FIG. 1 a schematic illustration of an embodiment of a circuit topology for a charging device with a control unit.

FIG. 2 shows a schematic illustration of a vehicle comprising a drive train with a charging device,

FIG. 3 shows a schematic illustration of a flowchart for a method for operating a charging device.

### DETAILED DESCRIPTION

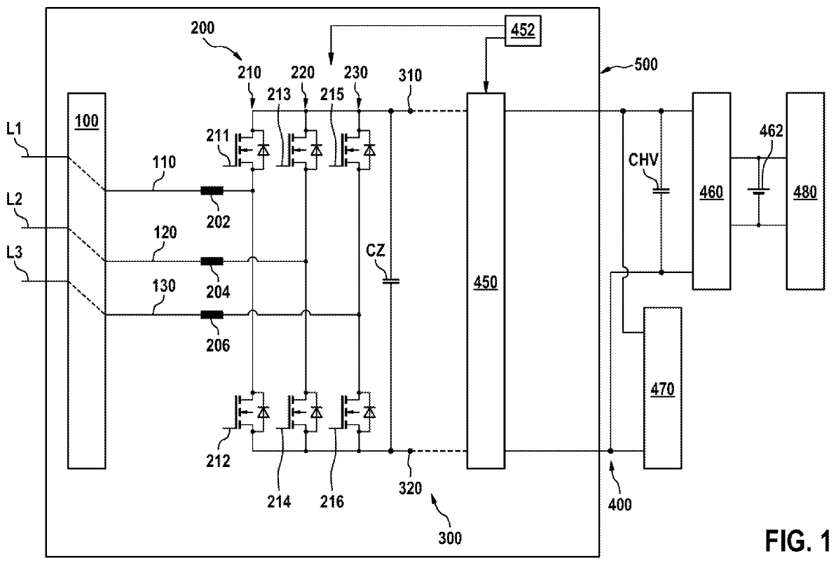

FIG. 1 shows a charging device 500, preferably for a vehicle. The charging device 500 comprises, on the input side, an input connection unit 100 for connecting an exemplary three-phase AC voltage, an input circuit 200 for supplying a DC voltage to an intermediate connection 300. An intermediate capacitor CZ is connected between the positive intermediate connection 310 and the negative intermediate connection 320. Furthermore, a bi-directional DC-DC converter 450 is connected to the intermediate connection 300. The DC voltage at the intermediate connection 300, which is applied to the input side of the DC-DC converter 450, is converted into a charging voltage in a charging mode and made available on the output side of the DC-DC converter 450 to provide a high-voltage network 400 connectable on the output side to the DC-DC converter 450 and/or to charge a battery 470 connectable on the output side of the DC-DC converter 450, preferably a traction battery or high-voltage battery. The high-voltage network 400 comprises at least one high-voltage capacitor CHV, a capacitance in the high-voltage network 400. The high-voltage capacitor CHV is shown as an example for at least one of the capacitances of the components connected to the high-voltage network 400.

In the event of an accident or before carrying out repairs on the vehicle, the capacitors of the vehicle's high-voltage network 400 (or high-voltage electrical system) must be reliably discharged so that there is no risk of injury to persons if they touch or come into contact with cables or components of the high-voltage electrical system. According to the invention, the DC-DC converter 450 is operated by means of a control unit 452 in a discharge mode such that the charge applied to the output side of the DC-DC converter 450 in the high-voltage network 400, preferably from the high-voltage capacitor CHV, is transported in the direction of the intermediate connection 300 and the intermediate capacitor CZ is charged. For this purpose, the control unit receives or determines a signal, preferably an error signal, whereupon the control unit 452 discharges the electrical charge applied to the DC-DC converter 450 on the output side by means of the discharge mode. Preferably, the charging device comprises a measuring device (not shown in FIG. 1 for reasons of clarity) which is configured to determine a measured value which characterizes the voltage applied to the output side of the DC-DC converter 450. This could be a measuring device for directly determining the voltage on the output side of the DC-DC converter. Alternatively, one or more measuring devices for determining one or more electrical parameters (current, voltage) on the input and/or output side of the DC-DC converter and an adapted calculation could be used to determine or characterize the voltage applied to the output side of the DC-DC converter 450 as a measured value. Similarly, a corresponding measured value or the voltage value can be transmitted to the control unit 452, preferably by means of a bus system from a component in the high-voltage network or on-board electrical system of the vehicle. The discharge mode is executed by means of the control unit 452 until the measured value corresponds to a predetermined threshold value, which characterizes a voltage value applied to the DC-DC converter 450 on the output side falling below a predetermined value. The voltage value applied to the output side of the DC-DC converter 450 is selected so that there is no danger to persons when the live components are touched.

An exemplary input circuit 200, an exemplary PFC stage, of the charging device 500 comprises a first 210, a second 220 and a third 230 half-bridge. The first, second, and third half-bridges 210, 220, 230 each include a series connection having a high-side switch 211, 213, 215 and a low-side switch 212, 214, 216. In each case, a center pickup between the high-side switch and the low-side switch of a half-bridge can be connected via a first, second and third inductor 202, 204, 206 to a first, second and third input connection L1, L2, L3 of the input connection unit 100 via a first, second and third connecting line 110, 120, 130 in each case. Thus, the center pickup of the first half-bridge 210 can be connected via the first inductor 202 to the first input connection L1 via the first connecting line 110. Thus, the center pickup of the second half-bridge 220 can be connected via the second inductor 204 to the second input connection L2 via the second connecting line 120. Thus, the center pickup of the third half-bridge 230 can be connected via the third inductor 206 to the third input connection L3 via the third connecting line 130. The half-bridges 210, 220, 230 are connected in parallel. Their ends are connected to the two-pole intermediate connection 300. The high-side switches are connected to a positive intermediate connection 310 and the low-side switches are connected to a negative intermediate connection 320.

Preferably, the high-voltage network 400 comprises several consumers. Thus, a further DC-DC converter 460, preferably a buck converter, is connected in parallel with the battery 470 to convert the charging voltage into a low voltage for charging a low-voltage battery 462 and for supplying an on-board electrical system of a vehicle for supplying the control devices of a vehicle. The low-voltage battery 462, and preferably also further low-voltage loads 480, are connected to the vehicle's on-board power supply.

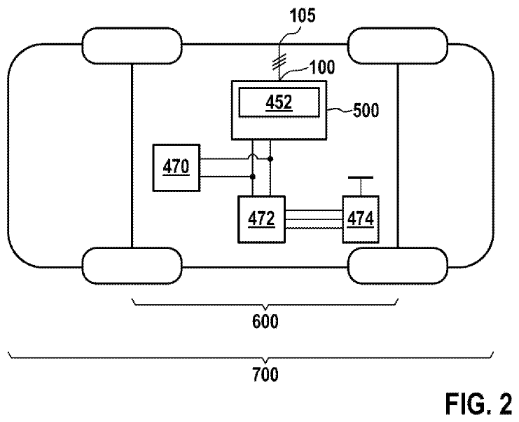

FIG. 2 shows a schematic illustration of a vehicle 700 comprising a drive train 600 with a charging device 500. The input connection unit 100 of the charging device 500 is preferably connectable to an external energy source via an electrical connection via a charger connection 105. Preferably, an external power source is connected to the charger connection 105 via a wall box. This connection is preferably used for charging mode. However, a feedback operation is also possible, in which energy from the battery 470 is fed back to the external power source. The vehicle 700 is shown here only as an example with four wheels, wherein the invention is equally applicable in any vehicles with any number of wheels on land, on water, and in the air. The exemplary drive train 600 comprises at least one charging device 500 with a control unit 452. Furthermore, the drive train preferably comprises a battery 470, an inverter 472 and/or or an electric machine 474. Any further consumers are preferred, which preferably comprise further capacitances between the high-voltage connections, are connected to the high-voltage network 400 of the drive train 600. The charging device 500 is shown here within the vehicle by way of example only. The charging device may also be designed as a stand-alone charging device 500, preferably as a charging station or wall box, and located outside a vehicle.

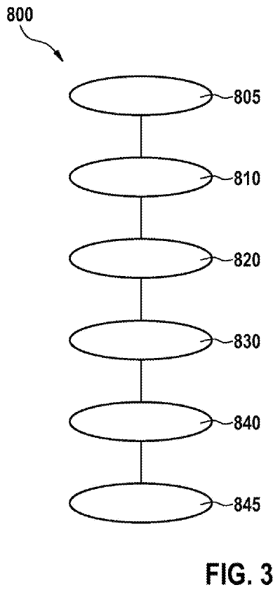

FIG. 3 shows a schematic flowchart for a method 800 for operating a charging device 500. The method 800 starts with step 805. In step 810, a signal is received for discharging the electrical charge applied to the DC-DC converter 450 on the output side. In step 820, a measured value is determined which characterizes a voltage applied to the output side of the DC-DC converter 450. In step 830, the DC-DC converter 450 is operated or controlled in a discharge mode such that that the charge applied to the DC-DC converter 450 on the output side is transported in the direction of the intermediate connection 300 and the intermediate capacitor CZ is charged until the determined measured value corresponds to a predeterminable threshold value which characterizes a falling below a predeterminable voltage applied to the output side of the DC-DC converter 450. In step 840, the intermediate capacitor CZ is preferably discharged by means of a discharge circuit. The method ends at step 845.

1. A method (800) for operating a charging device for a vehicle,
wherein the charging device (500) comprises, on the input side, an input connection unit (100) for connecting a single-phase or multiphase AC voltage with n phases, where n is greater than or equal to 1, and an input circuit (200) for supplying a DC voltage to a two-pole intermediate connection (300),
wherein an intermediate capacitor (CZ) is connected between the positive intermediate connection (310) and the negative intermediate connection (320),
wherein a bi-directional DC-DC converter (450) is connected on the input side to the intermediate connection (300), which is configured to convert the DC voltage applied to the intermediate connection (300) into a charging voltage in a charging mode and to provide it to a high-voltage network (400) connectable to the output side of the DC-DC converter (450),
wherein the method (800) is configured to at least partially reduce or discharge an electrical charge applied to the output side of the DC-DC converter (450),
said method comprising the following steps:
receiving (810) a signal for discharging the electrical charge applied to the output side of the DC-DC converter (450),
determining (820) a measured value that characterizes a voltage applied to the output side of the DC-DC converter (450), and
operating (830) the DC-DC converter (450) in a discharge mode such that the charge applied to the output side is transported in the direction of the intermediate connection (300) and the intermediate capacitor (CZ) is charged until the determined measured value corresponds to a predeterminable threshold value which characterizes a voltage value applied to the DC-DC converter (450) on the output side falling below a predeterminable value.

2. The method according to claim 1,
comprising the next step:
discharging (840) the intermediate capacitor (CZ) by means of a discharge circuit.

3. A control unit (452) for a charging device (500), which is configured to control a charging device (500) that comprises
on an input side, an input connection unit (100) for connecting a single-phase or multiphase AC voltage with n phases, where n is greater than or equal to 1, and an input circuit (200) for supplying a DC voltage to a two-pole intermediate connection (300),
an intermediate capacitor (CZ) connected between the positive intermediate connection (310) and the negative intermediate connection (320), and
a bi-directional DC-DC converter (450) connected on the input side to the intermediate connection (300), which is configured to convert the DC voltage applied to the intermediate connection (300) into a charging voltage in a charging mode and to provide it to a high-voltage network (400) connectable to the output side of the DC-DC converter (450).
by:
receiving (810) a signal for discharging the electrical charge applied to the output side of the DC-DC converter (450),
determining (820) a measured value that characterizes a voltage applied to the output side of the DC-DC converter (450), and
operating (830) the DC-DC converter (450) in a discharge mode such that the charge applied to the output side is transported in the direction of the intermediate connection (300) and the intermediate capacitor (CZ) is charged until the determined measured value corresponds to a predeterminable threshold value which characterizes a voltage value applied to the DC-DC converter (450) on the output side falling below a predeterminable value.

4. A charging device with a control unit (452) according to claim 3, wherein the input side of the charging device (500) comprises an input connection unit (100) for connecting a single-phase or multiphase alternating voltage with n phases, wherein n is greater than or equal to 1, and an input circuit (200) connected thereto for supplying a DC voltage to a two-pole intermediate connection (300),
wherein an intermediate capacitor (CZ) is connected between the positive intermediate connection (310) and the negative intermediate connection (320),
wherein a bi-directional DC-DC converter (450) is connected to the intermediate connection (300) on the input side, and is configured to convert the DC voltage applied to the intermediate connection (300) into a charging voltage and to supply it to a high-voltage network (400) connectable to the output side of the DC-DC converter (450).

5. The charging device according to claim 4, wherein the intermediate capacitor (CZ) comprises at least one electrolytic capacitor.

6. The charging device according to claim 4, wherein the bi-directional DC-DC converter (450) comprises at least one LLC, CLLC, or dual active bridge circuit.

7. A drive train (600) of a vehicle (700) with a control unit (452) according to claim 3, wherein the drive train (600) comprises a traction battery (470), an inverter (472) and/or an electric machine (474).

8. A vehicle (700) having a drive train (600) according to claim 7.

9. (canceled)

10. A non-transitory, computer-readable storage medium comprising instructions which, when executed by a control unit (452), cause control a charging device (500) that comprises
on an input side, an input connection unit (100) for connecting a single-phase or multiphase AC voltage with n phases, where n is greater than or equal to 1, and an input circuit (200) for supplying a DC voltage to a two-pole intermediate connection (300).
an intermediate capacitor (CZ) connected between the positive intermediate connection (310) and the negative intermediate connection (320), and
a bi-directional DC-DC converter (450) connected on the input side to the intermediate connection (300), which is configured to convert the DC voltage applied to the intermediate connection (300) into a charging voltage in a charging mode and to provide it to a high-voltage network (400) connectable to the output side of the DC-DC converter (450),
by:
receiving (810) a signal for discharging the electrical charge applied to the output side of the DC-DC converter (450),
determining (820) a measured value that characterizes a voltage applied to the output side of the DC-DC converter (450), and
operating (830) the DC-DC converter (450) in a discharge mode such that the charge applied to the output side is transported in the direction of the intermediate connection (300) and the intermediate capacitor (CZ) is charged until the determined measured value corresponds to a predeterminable threshold value which characterizes a voltage value applied to the DC-DC converter (450) on the output side falling below a predeterminable value.

11. A drive train (600) of a vehicle (700) with a charging device (500) according claim 4, wherein the drive train (600) comprises a traction battery (470), an inverter (472) and/or an electric machine (474).
